(19) United States
(12) Patent Application Publication
(10) Pub. No.: US 2005/0146739 A1
(43) Pub. Date: Jul. 7, 2005

(54) Method and apparatus for print driver simplex/duplex control

(76) Inventors: Cody Rayl, Boise, ID (US); Tobias M. Clary, Boise, ID (US); Cathy Scarlett, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/746,091

(22) Filed: Dec. 26, 2003

(51) Int. Cl. G06F 15/00

(52) U.S. Cl. 358/1.13

(57) ABSTRACT

A method and apparatus for print driver simplex/duplex control. In representative embodiments, the method is performed by a print driver. The print driver receives a request for a printer to perform a print task. The print task includes printing at least one computer generated page in duplex format and at least one other computer generated page in simplex format, and the order of the pages in an organized sequence is specified. Then the driver transmits a command to the printer to perform the print task with the pages in the print task being specified to be printed in accordance with the specified format and sequence order.

### BACKGROUND

Printing of computer stored or generated material is an important function in modern computer systems. Typically the print format of this material is controlled in one or more of three places—(1) a control module of the printer selected to print the material, (2) a print driver typically residing on a computer that forms a print interface between the computer and the printer, and (3) a computer application running on the computer that has access to the material.

As a general rule, control by the computer application takes precedence over control by the print driver which in turn takes precedence over control by the print control module. If the printer is capable of printing on both sides of the paper, referred as duplex printing, that option in the printer's control module can be selected by an operator from the printer's control panel. Unless instructed otherwise by the print driver, the printer will then print all print jobs, also referred to herein as print tasks, in duplex mode. This choice can be overridden by selecting printing on only one side, referred to herein as simplex printing, in the printer driver.

### SUMMARY

In representative embodiments, a method for simplex/duplex control of a print driver is described. The print driver receives a request for a printer to perform a print task. The print task includes printing at least one computer generated page in duplex format and at least one other computer generated page in simplex format, and the order of the pages in an organized sequence is specified. Then the driver transmits a command to the printer to perform the print task with the pages in the print task being specified to be printed in accordance with the specified format and sequence order.

In another representative embodiment, the print driver includes a means for receiving a request for the printer to perform the print task. The print task includes printing at least one computer generated page in duplex format and at least one other computer generated page in simplex format. The order of the pages is specified in an organized sequence. The print driver further includes a means for transmitting a command to the printer to perform the print task. The pages in the print task are specified to be printed in accordance with the specified format and sequence order.

Other aspects and advantages of the present invention will become apparent from the following detailed description, taken in conjunction with the accompanying drawings, illustrating by way of example the principles of the invention.

### BRIEF DESCRIPTION OF THE DRAWINGS

The accompanying drawings provide visual representations which will be used to more fully describe the invention and can be used by those skilled in the art to better understand it and its inherent advantages. In these drawings, like reference numerals identify corresponding elements.

FIG. 1 is a drawing of a system for control of a print task as described in various representative embodiments.

FIG. 2 is a drawing of a dialog box for a print driver as described in various representative embodiments.

FIG. 3 is a drawing of an arrangement of printed sheets of paper as described in various representative embodiments.

FIG. 4 is a drawing of a flow chart for controlling the print task as described in various representative embodiments.

FIG. 5 is a drawing of print task control components and commands as described in various representative embodiments.

### DETAILED DESCRIPTION

As shown in the drawings for purposes of illustration, the present patent document relates to a novel method for controlling the printing of a print job, also referred to herein as a print task. Previous methods for printing the print job have permitted the job to be printed either all in simplex format or all in duplex format. In representative embodiments, techniques are described herein that provide flexibility within the print job allowing selected pages to be printed in simplex mode and other selected pages to be printed duplex mode.

In the following detailed description and in the several figures of the drawings, like elements are identified with like reference numerals.

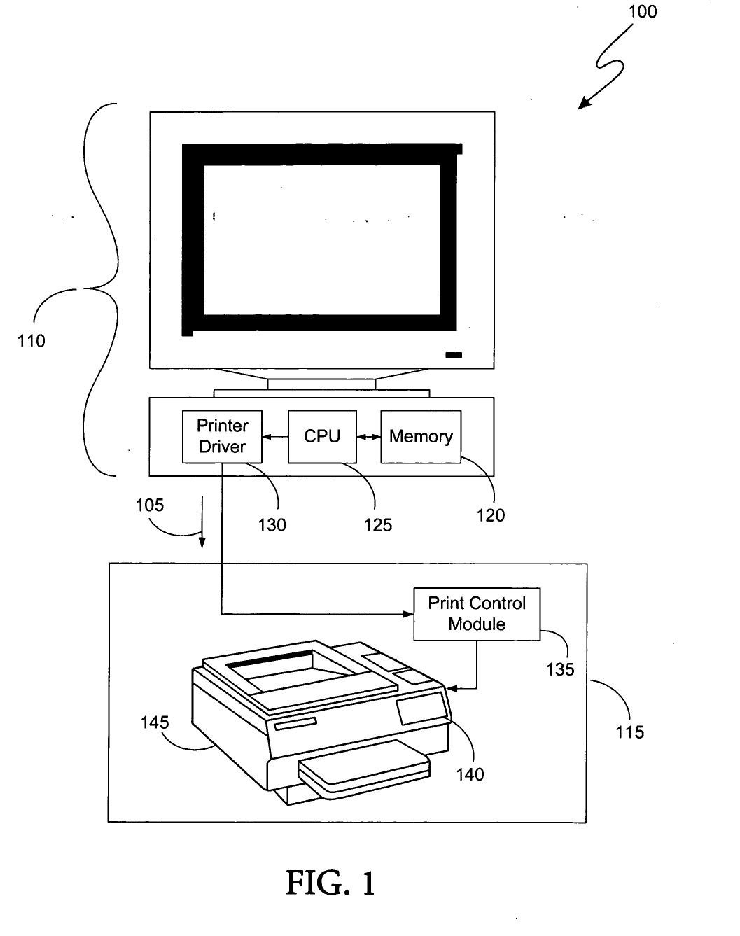

FIG. 1 is a drawing of a system 100 for control of a print task 105 as described in various representative embodiments. In FIG. 1, the system 100 comprises a computer 110 and a printer 115. The computer further comprises a memory 120, a central processing unit (CPU) 125, and a print driver 130, and the printer 115 further comprises a print control module 135, a printer panel 140, and other printer hardware 145. Print options controlled by the printer's control module 135 can be selected by an operators from the printer's control panel 140.

In a representative example, when an application program stored in the memory 120 of the computer 110 is ready to send a print job to the printer 115, the application program accesses the print driver 130 via the central processing unit 125. An operator then selects the page or pages to be printed in simplex mode and those to be printed in duplex mode. The print driver 130 translates the operator selected pages and corresponding print modes into an ordered set of commands which are then sent to the print control module 135. These commands instruct the print control module 135 as to the pages to be printed and as to the mode to print them in. The commands typically would be transmitted sequentially from the print driver 130 in the order of the paging of the document to be printed.

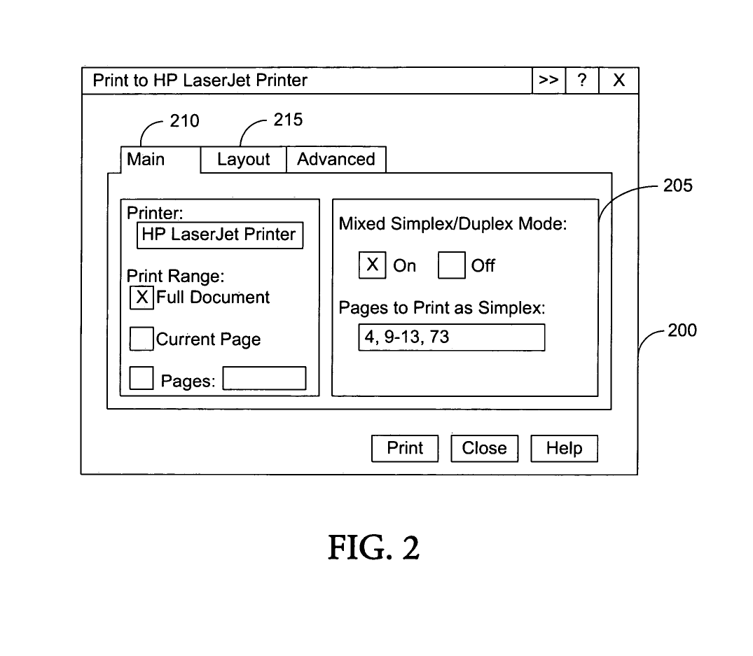

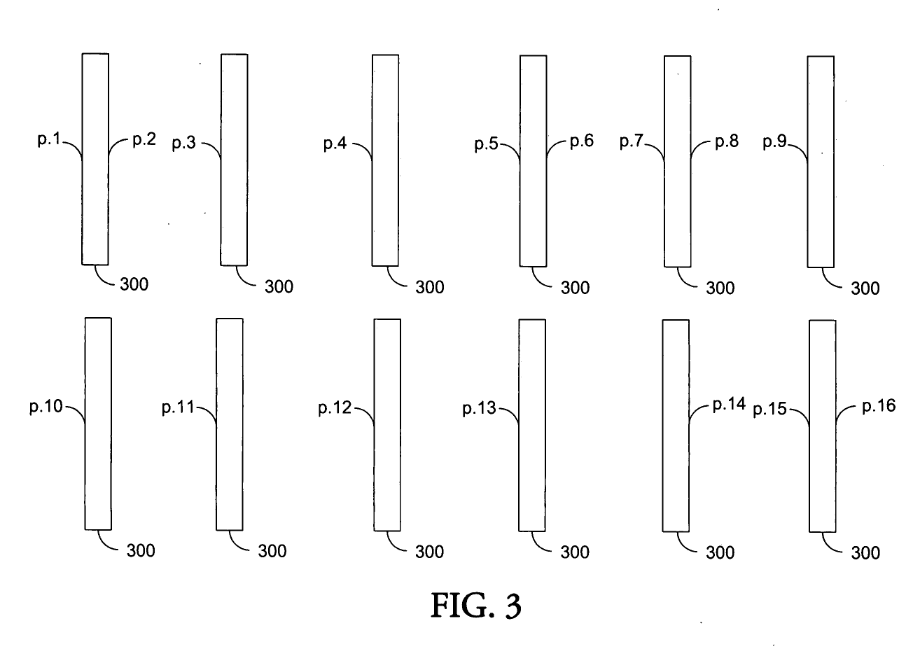

FIG. 2 is a drawing of a dialog box 200 for the print driver 130 as described in various representative embodiments. The dialog box 200 of FIG. 2 will pop-up within an application display when the command to print is given. In the example embodiment of FIG. 2, a print mode sub-menu 205 within the main menu 210 provides the option of turning the mixed simplex and duplex print mode on. Selection of only simplex or only duplex can be made, for example, from the layout menu 215. In the example of FIG. 2, mixed simplex/duplex mode is turned on. Pages 4, 9-13, and 73 are to be printed simplex on individual sheets of paper while the rest of the pages in the print job will be printed duplex. Note that in this example, pages 1 and 2 are printed duplex on the same sheet of paper, page 3 is printed duplex but without a printed back side as page 4 has been specified to be printed simplex. Page 4 is printed simplex on a single sheet. Pages 5 and 6 are printed duplex on the same sheet, as are pages 7 and 8. Pages 9-13 are printed simplex on individual sheets. The next sheet of paper is printed duplex without a printed front side as page 13 has been specified to be printed simplex, but page 14 is printed on the back side of the sheet. Pages 15-72 are printed duplex. Page 73 is then printed simplex. Pages following page 73 are printed duplex in a manner similar to that just described. Printing the combination of duplex and simplex formats as just described maintains the consistency of odd numbered pages, for example on the front sides, and even numbered pages, again for example on the back sides of the sheets of paper. In another representative embodiment, the consistency of odd numbered pages is not maintained so as to always be printed, for example, on the front side of each sheet of paper, nor is the consistency of even numbered pages maintained so as to always be printed, for example, on the back side of each sheet of paper FIG. 3 is a drawing of an arrangement of printed sheets of paper 300 as described in various representative embodiments. The arrangement is as described in the preceding paragraph, but only for pages 1-16. The sheets 300 are shown in edge view, not to scale, and with the thickness of each sheet exaggerated for purposes of illustration.

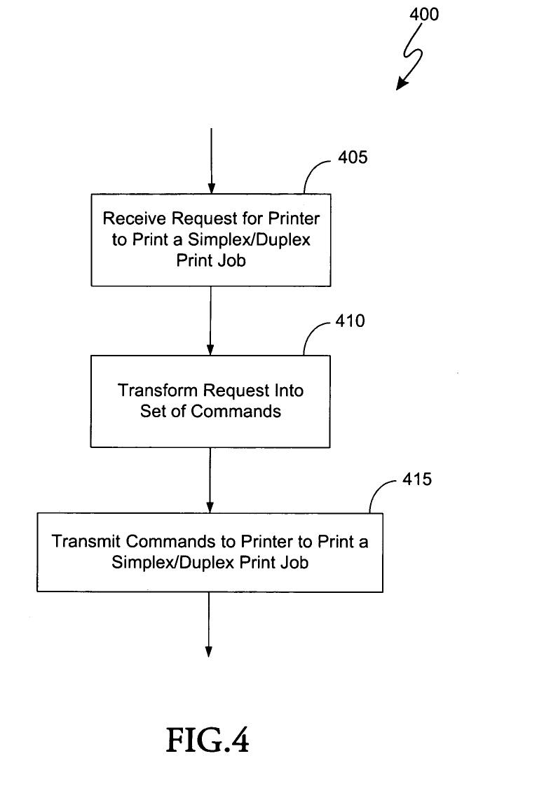

FIG. 4 is a drawing of a flow chart 400 for controlling the print task 105 as described in various representative embodiments. In block 405, the print driver 130 receives a request for the printer 115 to perform the print task 105, wherein the print task 105 comprises printing at least one computer generated page in duplex format and at least one other computer generated page in simplex format and wherein the order of the pages in an organized sequence is specified. Block 405 then transfers control to block 410.

In block 410, the print driver 130 transforms the operator selections as to pages and associated print modes to be printed from, for example, the print mode sub-menu 205 of FIG. 2 into a sequence of print commands which are readable by the print control module 135. Block 410 then transfers control to block 415.

In block 415, the print driver 130 transmits a set of commands to the printer 115 to perform the print task 105, wherein the pages in the print task 105 are specified to be printed in accordance with the specified format and sequence order. These commands instruct the print control module 135 as to the pages to be printed and as to the mode to print them in. The commands typically would be transmitted sequentially from the print driver 130 in the order of the paging of the document to be printed. Block 415 then terminates the process.

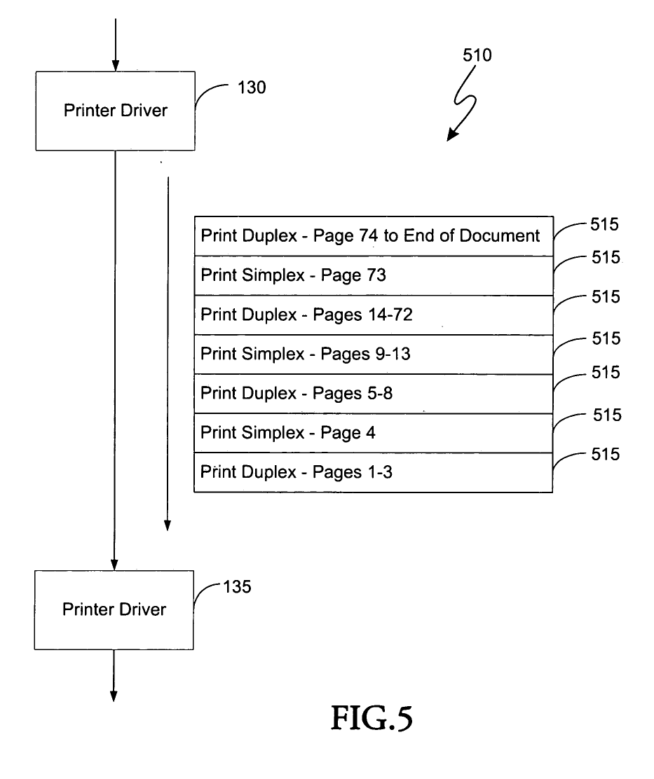

FIG. 5 is a drawing of print task control components and commands as described in various representative embodiments. In FIG. 5, the print driver 130 translates the operator selected pages and corresponding print modes into an ordered set of commands 510 which are then sent to the print control module 135. The set of commands 510 typically comprises individual commands 515 which instruct the print control module 135 as to the pages to be printed and as to the mode to print them in. The commands typically would be transmitted sequentially from the print driver 130 in the order of the paging of the document to be printed.

Using the example of FIG. 2, wherein mixed simplex/duplex mode is turned on, pages 4, 9-13, and 73 are to be printed simplex on individual sheets of paper while the remainder of the pages in the print job will be printed duplex. In FIG. 5, the command 515 transmitted first by the printer driver 130 is the command 515 to “Print Duplex—Pages 1-3” which would print pages 1 and 2 duplex on the same sheet of paper and print page 3 duplex but without a printed back side, the second command 515 is the command to “Print Simplex—Page 4” which would print page 4 simplex on a single sheet, the third command 515 is the command 515 to “Print Duplex—Pages 5-8” which would print pages 5 and 6 duplex on the same sheet and pages 7 and 8 duplex on another sheet, the fourth command 515 is the command 515 to “Print Simplex—Pages 9-13” which would print pages 9-13 simplex on individual sheets, the fifth command 515 is the command 515 to “Print Duplex—Pages 14-72” which would print the next sheet duplex without a printed front side but with page 14 printed on the back side of the sheet and print pages 15-72 duplex, the sixth command 515 is the command 515 to “Print Simplex—Page 73” which would print page 73 simplex, and the seventh command 515 is the command 515 to “Print Duplex—Page 74 to End of Document” which would print pages 74 through to the end of the document in duplex mode.

In the example of FIG. 2, the pages to print as simplex are specified in the print mode sub-menu 205. In another representative embodiment, the pages to print as duplex would be specified in the print mode sub-menu 205. And in still another representative embodiment, printing is limited to a selected range of page numbers, as for example, printing only pages 4-20 instead of the complete document.

As is the case, in many data-processing products, the print driver 130 may be implemented either as a combination of hardware, firmware, and software components or from a single one of these components. Moreover, the functionality required for representative implementations may be embodied in a computer-readable medium. The term “computer-readable medium” is broadly defined herein to include any kind of computer memory such as, but not limited to, floppy disks, conventional hard disks, DVD's, CD-ROM's, Flash ROM's, nonvolatile ROM, and RAM.

The computer 110 can run any commercially available operating system such as, but not limited to, various versions of DOS, Windows, Macintosh, UNIX, or any other suitable operating system. The computer application programs can include Microsoft Windows, Microsoft Excel, CorelDraw, WordPerfect, or any other suitable application program.

An advantage of the embodiments as described herein is the ability to send a single print job with a mixture of simplex and duplex pages to a printer.

While the present invention has been described in detail in relation to preferred embodiments thereof, the described embodiments have been presented by way of example and not by way of limitation. It will be understood by those skilled in the art that various changes may be made in the form and details of the described embodiments resulting in equivalent embodiments that remain within the scope of the appended claims.

1. A computer-readable medium having computer-executable instructions for performing a method, comprising:
by a print driver:
receiving a request for a printer to perform a print task, wherein the print task comprises printing at least one computer generated page in duplex format and at least one other computer generated page in simplex format and wherein the order of the pages in an organized sequence is specified;
transforming the request into a sequence of print commands; and
transmitting the sequence of commands to the printer to perform the print task, wherein the pages in the print task are specified to be printed in accordance with the specified format and sequence order.

2. A computer operable method, comprising:
by a print driver, receiving a request for a printer to perform a print task, wherein the print task comprises printing at least one computer generated page in duplex format and at least one other computer generated page in simplex format and wherein the order of the pages in an organized sequence is specified;
by the print driver, transforming the request into a sequence of print commands; and
by the print driver, transmitting a command to the printer to perform the print task, wherein the pages in the print task are specified to be printed in accordance with the specified format and sequence order.

3. The computer operable method as recited in claim 2, wherein the request in the receiving step is initiated by an operator.

4. The computer-readable medium as recited in claim 2, wherein the request in the receiving step is initiated by a computer program.

5. A print driver, comprising:
means for receiving a request for a printer to perform a print task, wherein the print task comprises printing at least one computer generated page in duplex format and at least one other computer generated page in simplex format and wherein the order of the pages in an organized sequence is specified;
means for transforming the request into a sequence of print commands, wherein each command in the sequence specifies at least one page and the print format; and
means for transmitting a command to the printer to perform the print task, wherein the pages in the print task are specified to be printed in accordance with the sequence order of the commands.

6. The print driver as recited in claim 5, wherein the means for receiving the request to print the print task is a software program.

7. The print driver as recited in claim 5, wherein the means for receiving the request to print the print task is a firmware module.

8. The print driver as recited in claim 5, wherein the means for receiving the request to print the print task is a hardware module.

9. The print driver as recited in claim 5, wherein the means for transmitting the commands to print the print task is a software program.

10. The print driver as recited in claim 5, wherein the means for transmitting the commands to print the print task is a firmware module.

11. The print driver as recited in claim 5, wherein the means for transmitting the commands to print the print task is a hardware module.

12. The print driver as recited in claim 5, wherein the print driver is located on a computer.

13. The print driver as recited in claim 5, wherein the means for transforming the request to print the print task is a software program.

14. The print driver as recited in claim 5, wherein the means for transforming the request to print the print task is a firmware module.

15. The print driver as recited in claim 5, wherein the means for transforming the request to print the print task is a hardware module.
